(19) United States
(12) Patent Application Publication
(10) Pub. No.: US 2005/0214641 A1
(43) Pub. Date: Sep. 29, 2005

(54) Cap assembly and secondary battery using the same

(76) Inventor: Yong-Sam Kim, Suwon-si (KR)

Correspondence Address: Robert E. Bushnell, Suite 300, 1522 K Street, N.W., Washington, DC, 20005-1202, US

(21) Appl. No.: 11/087,698

(22) Filed: Mar. 24, 2005

(30) Foreign Application Priority Data
Mar. 24, 2004 (KR) 10-2004-0019953

(51) Int. Cl. H01M 2/08; H01M 2/02; H01M 2/12; H01M 2/00

(52) U.S. Cl. 429/175; 429/170; 429/53; 429/82; 429/163

(57) ABSTRACT

A cap assembly for a secondary battery maybe constructed with a cap cover, a tab plate arranged along one side of the cap cover, and a vent plate arranged between the cap cover and the tab plate. The tab plate has a current breaking portion configured to be torn by a predetermined force, and the vent plate has a vent dedicated to be altered, or broken, by a predetermined force. The current breaking portion is attachedly fixed to the vent, and the center point of the current breaking portion and the point where the current breaking portion is attached to the vent are not coincident.

### CLAIM OF PRIORITY

This application makes reference to, incorporates the same herein, and claims all benefits accruing under 35 U.S.C. §119 from an application for CAP ASSEMBLY AND SECONDARY BATTERY USING THE SAME earlier filed in the Korean Intellectual Property Office on 24 Mar. 2004 and there duly assigned Serial No. 10-2004-0019953.

### BACKGROUND OF THE INVENTION

1. Field of the Invention

The present invention relates to a secondary battery and, more particularly, to a cap assembly of the secondary battery.

2. Description of the Related Art

Unlike the primary battery, the secondary battery may be recharged. Common types of secondary batteries include the nickel-hydrogen battery, the lithium battery and the lithium-ion battery. In particular, among the secondary batteries, the lithium secondary battery is more suitable for the portable electronic fields since it furnishes a high driving voltage and high energy density per unit weight. Recently, active research has been carried out to apply the lithium secondary battery as a power source for motors in hybrid electric vehicles (HEV).

When the secondary battery is grossly charged in excess of the charging capacity or if the positive electrode and negative electrode of the electrode assembly are short-circuited, a secondary battery generates gas inside the battery which increases the internal pressure, and which may cause an explosion and ignition of the battery.

In an effort to overcome these difficulties attributable to excessive charge and short-circuiting of the electrodes, the secondary battery generally has a safety device, such as either a shut-down separator, a PTC (positive temperature coefficient) device, or a safety vent.

Such a safety device structure is not appropriate for high power batteries for use in motor driving devices such as the hybrid electric vehicles.

I have noticed that the construction of safety devices such as the safety vents currently designed for secondary batteries depends upon a design that when responding to a build-up of internal pressure caused by the generation of gas attributable to either a short-circuiting of the positive and negative electrodes or to an excessive over-charging of the battery, tends to break a path of electrical current flow between the electrode assembly and the cap assembly and thereby cause the battery to fail as the gas is vented to atmosphere.

### SUMMARY OF THE INVENTION

It is therefore one object to the present invention to provide a cap assembly for a secondary battery and a secondary battery incorporating a cap assembly, which can minimize resistant factors generated in the current flow from the electrode assembly to the cap assembly and facilitate the operation of the vent.

According to one aspect of the present invention, a cap assembly for a secondary battery may be constructed with a cap cover, a tab plate arranged along one side of the cap cover, and a vent plate arranged between the cap cover and the tab plate. The tab plate has a current breaking portion to be torn by a predetermined force, and the vent plate has a vent to be altered, or broken, by a predetermined force. The current breaking portion is fixed to the vent, and the center point of the current breaking portion and the fixed point of the current breaking portion to the vent are not coincident.

The tab plate may have a notch formed along the circumference of the current breaking portion.

The tab plate may have at least one ventilation hole.

The current breaking portion may be formed such that the shapes of the regions bisected by a hypothetical line passing through the fixed point are not symmetrical, and the overall shape of the current breaking portion can be a trapezoid or triangle.

The current breaking portion and the vent can be fixed by welding.

A slit may be formed between the body of the tab plate and the current breaking portion corresponding to at least a portion of the circumference of the current breaking portion. The slits may be arranged to be opposite to each other with respect to the fixed point.

The cap assembly meets the following formula:
a<b (1)
where “a” is the distance from the fixed point to one point of the edge of the current breaking portion and “b” is the distance from the fixed point to the cap cover.

According to another aspect of the invention, a secondary battery may be constructed with a container, an electrode assembly mounted in the container having a positive electrode, a negative electrode, and a separator interposed between the positive electrode and the negative electrode; and a cap assembly fixed across an opening of the container to seal the container. The cap assembly may include a cap cover, a tab plate arranged along one side of the cap cover, and a vent plate arranged between the cap cover and the tab plate. The tab plate has a current breaking portion to be torn by a predetermined force, and the vent plate has a vent to be altered or broken by a predetermined force. The current breaking portion is fixed to the vent, and the center point of the current breaking portion and the fixed point of the current breaking portion to the vent are not coincident.

The secondary battery may have a cylindrical shape.

The secondary battery may be used to provide electrical power for a motor driven device.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of a secondary battery;

FIG. 2 is a cross-sectional view of a secondary battery constructed as a first embodiment of the present invention;

FIG. 3 is a bottom view of the tab plate of FIG. 2;

FIGS. 4A through 4C are schematic drawings illustrating a sequence in the operational status of the secondary battery of the first embodiment of the present invention;

FIGS. 5A through 5C are schematic drawings illustrating the current breaking portion of a battery constructed as a second embodiment of the present invention; and

FIGS. 6A through 6C are schematic drawings illustrating an operational sequence showing the current breaking portion of a battery as a third embodiment of the present invention.

### DETAILED DESCRIPTION OF THE EMBODIMENTS

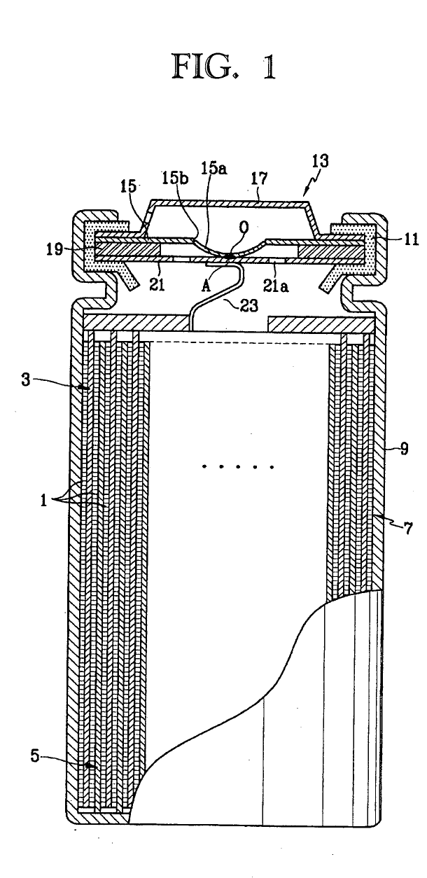

Referring now to FIG. 1 a cross-sectional view showing that a secondary battery may be constructed with an electrode assembly 7 including a positive electrode 3, a negative electrode 5, and a separator 1 interposed between electrodes 3, 5, container 9 for receiving electrode assembly 7 together with an electrolyte within the interior of container 9, and a cap assembly 13 mounted across an opening of container 9 with a gasket 11, to close off and seal the opening of container 9 of with a gasket 11, to close off and seal the opening of container 9.

Cap assembly 13 includes a cap cover 17, a vent plate 15, an insulator 19, and a tab plate 21, arranged sequentially from the top to the bottom of the battery.

Tab plate 21 is fixed to positive electrode tab 23 connected to positive electrode 3 of electrode assembly 7; tab plate 21 is perforated by a plurality of holes 21a to ventilate gas.

Vent plate 15 has a vent 15a of a concave shape formed at its center. Vent 15a is fixed to tab plate 21 by welding. A notch 15b with a predetermined depth is formed along the circumference of vent 15a by mechanical processing or by etching. Notch 15b makes vent 15a more fragile in comparison to other portions of vent plate 15 to allow alteration. Then, vent 15a has a circular or oval shape, and it has a structure that at its center point (O) is coincident with the welding point (A) with the tab plate 21.

When gas is generated inside the battery, the internal pressure increases and vent 15a is forced outwardly and upwardly until vent 15a separates from tab plate 21. Accordingly, the current flow from positive electrode tab 23 toward cap cover 17 is cut off, and if the internal pressure increases further, vent 15a tends to be torn along notch 15b to discharge the gas and thereby alleviate the pressure.

This design for a secondary battery has a structural safety device that interrupts the electrical current flow by separating vent 15a from tab plate 21 at welding point (A). Generally the welding strength of vent 15a and tab plate 21 is set to a low value in order to facilitate the easy operation of vent 15a. That is, this design for a secondary battery has a structure with vent 15a and tab plate 21 fixed with a minimum of welding strength necessary to form the electrical current path between tab plate 21 and vent plate 15.

Accordingly, vent 15a functions adequately as a safety device for a secondary battery that is in use in everyday service, but lacks insufficient welding strength between vent 15a and tab plate 21 to allow the contact resistance to be increased in this region. This prevents adequate transmission of sufficient electrical current from electrode assembly 7 to cap assembly 13, and thereby forestalls maximization of the secondary battery's performance.

Such a safety device structure is inappropriate for high power batteries suitable for powering electric motors in hybrid electric vehicles.

Reference will now be made in detail to the embodiments of the present invention, examples of which are illustrated in the accompanying drawings. The embodiments are described below to explain the present invention by referring to the figures.

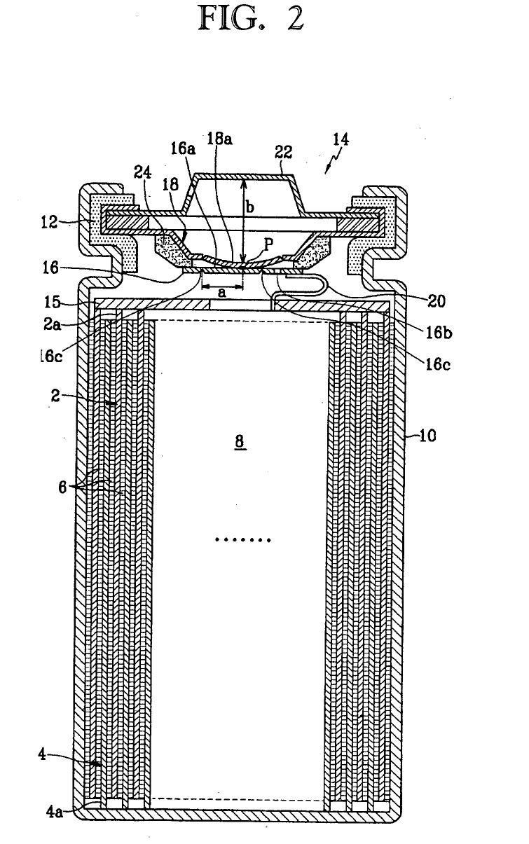

FIG. 2 is a cross-sectional view of a secondary battery constructed according to a first embodiment of the present invention.

As shown in FIG. 2, the secondary battery which maybe constructed with an electrode assembly 8 including a positive electrode 2, a negative electrode 4, and a separator 6 interposed between those two electrodes, container 10 receiving inside the container the electrode assembly 8 together with an electrolyte, and a cap assembly 14 mounted across an opening of container 10 through a gasket 12 to thereby close off and seal container 10.

Container 10 is made of an electrically conductive metal such as aluminum, aluminum alloy, or steel plated with nickel, and container 10 may have a cylindrical shape with an inner space to receive electrode assembly 8. The shape of container 10 is not limited to the cylindrical shape.

Electrode assembly 8 has either a stacked layer structure such that separator 6 is disposed between positive electrode 2 and negative electrode 4, or a jellyroll structure such that positive electrode 2, negative electrode 4 and separator 6 arranged in a stacked layer are wound into a jellyroll configuration.

The embodiment of the present invention shows a battery with a structure that uses container 10 with a cylindrical shape and electrode assembly 8 with a jellyroll configuration.

Electrode assembly 8 mentioned above is mounted inside container 10. In negative electrode 4, an uncoated region 4a of the collector of negative electrode 4 which is not coated with the active negative material is arranged to physically contact container 10; therefore, container 10 can function as a negative terminal. Similarly, positive electrode 2, and tab 20 are connected to collector plate 15 combined with an uncoated region 2a of positive electrode 2 which is not coated with the active positive material. Tab 20 is electrically connected to cap assembly 14 in order that cap assembly 14 can function as a positive terminal.

In an embodiment of the present invention, cap assembly 14 includes cap cover 22, vent plate 18, insulator 24, and tab plate 16, which are arranged sequentially from the top to the bottom of this embodiment of a secondary battery.

The upper surface of tab plate 16 is fixed to vent 18a of vent plate 18 by welding, and the lower surface of tab plate 16 is fixed to a positive electrode tab 20 by welding. Moreover, tab plate 16 has a plurality of ventilation through holes 16b to ventilate gas that is generated inside container 9 while the secondary battery is in use.

The secondary battery of the present invention improves the structure of tab plate 16 in order to minimize resistant factors which occur in the upon path of electrical current from tab 20 through tab plate 16 and the vent plate 18 to the cap cover 22, and thereby ability of the battery to readily and continuously provide electrical energy.

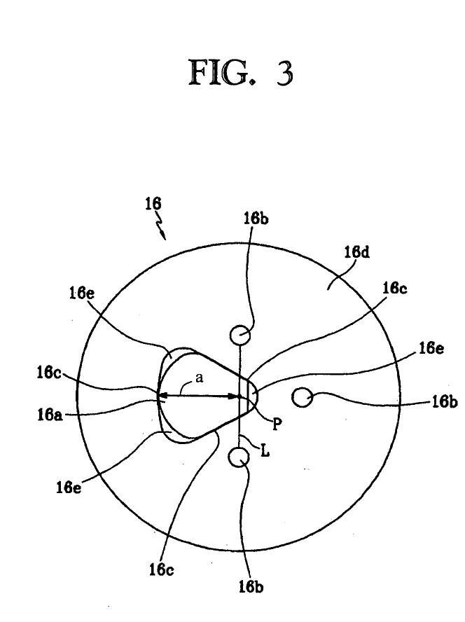

FIG. 3 is a bottom view of the tab plate of FIG. 2.

With reference to FIGS. 2 and 3, tab plate 16 has a current breaking portion 16a on its body 16d together with a ventilation hole 16b. The current breaking portion 16a is fixed to the vent 18a of the vent plate 18 by welding.

Current breaking portion 16a is a region of tab plate 16 which becomes more fragile compared with other portions when a predetermined force is applied, and thereby it can be easily altered and torn away from the remainder of tab plate 16. To achieve this, a notch 16c with a predetermined depth is formed along an inner periphery of circumference of current breaking portion 16a by mechanical processing or etching, to thereby delimit portion 16a within the surrounding surface of tab plate 16.

Notch 16c is not necessary to be formed along the entire circumference of current breaking portion 16a. As shown in the drawings, slit 16e can be formed along at least one portion of the periphery of circumference of current breaking portion 16a. Slit 16e is a portion to facilitate the tearing of the material of tab plate 16 along notch 16c when the current breaking portion 16a is torn from the tab plate 16. FIG. 3 shows that slits 16e are arranged to be opposite to each other with respect to fixed point (P).

Ventilation hole 16b is formed on body 16d, which is positioned outside current breaking portion 16a, and positive electrode tab 20 is fixed to body 16d by welding.

Tab plate 16 of the practice of the present invention, current breaking portion 16a is fixed to vent 18a of vent plate 18 more firmly than in a conventional design for secondary battery by increasing the welding strength of a weld made between current breaking portion 16a and vent 18a at point (P). This lowers the contact resistance at the welding point (P) in order to facilitate electrical current flow along the current path.

When it is necessary to cut off the current flow due to an increase of internal pressure, the secondary battery of the present invention provides the structure, as a safety device, that enables the gas generated from the inside of the battery to push vent 18a upwardly, thereby current breaking portion 16a is torn from tab plate 16, rather than tab plate 16 and vent plate 18 being physically separated at weld point (P).

Current breaking portion 16a has an eccentric shape so that fixed point (P) with vent 18a is not coincident with the geometric center, which allows current breaking portion 16a to be broken from the edge of tab plate 169 near the fixed point (P) when it is torn from the tab plate 16 by increasing internal pressure.

For example, when a hypothetical line (L) is disposed on fixed point (P) to pass through fixed point (P), the regions of current breaking portion 16a bisected by line (L) have nonsymmetrical shapes. FIG. 3 shows that the area of current breaking portion 16a increases like a shellfish shape as the distance the fixed point (P) is increases.

It is preferable that current breaking portion 16a meet the following formula for an inequality with respect to the entire structure of cap assembly 14:
a<b (1)
where “a” is the distance from fixed point (P) to one “point” (the point being located perpendicularity to line L in FIG. 3) on an edge of the current breaking portion 16a, and “b” is the vertical distance from fixed point (P) to cap cover 22.

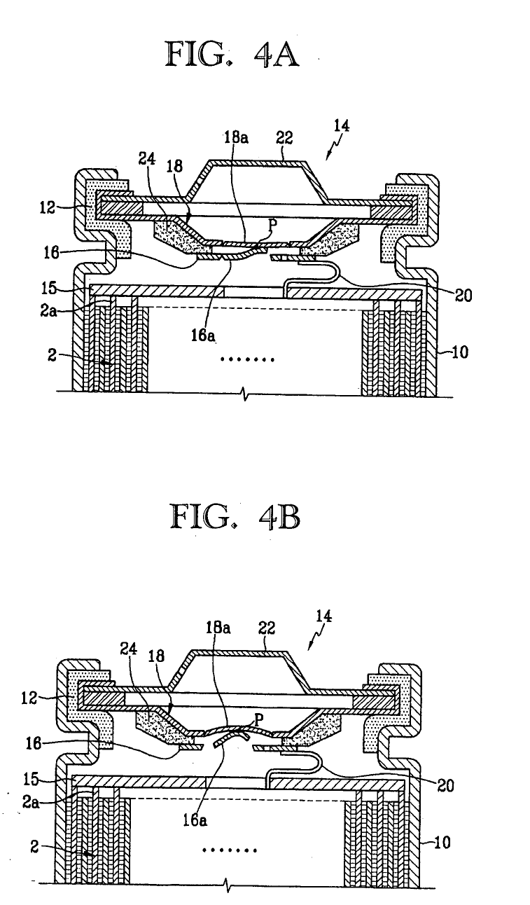

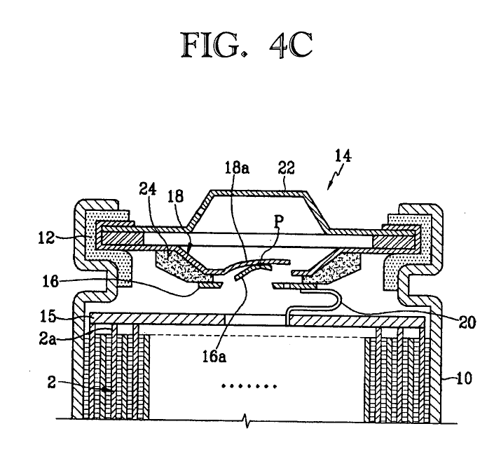

FIGS. 4A to 4C are cross-sectional views illustrating the operational status of the secondary battery constructed as the first embodiment of the principles of the present invention.

When the secondary battery is charged to an excess of its charging capacity, or when the positive electrode and negative electrode of the electrode assembly are short-circuited, the secondary battery generates gas inside the battery, thereby substantially increases the internal pressure. The gas passes through ventilation hole 16b of the tab plate 16, thereby pushing vent 18a of vent plate 18 upwardly.

Then, since vent 18a and current breaking portion 16a are fixed firmly together, they do not separated at fixed point (P) as would occur in earlier secondary battery designs, but current breaking portion 16a and vent 18a are torn from tab plate 16a by alteration and concomitant of current breaking portion 16a accompanying with the alteration deformation during the raising of vent 18a.

The separation between current breaking portion 16a and tab plate 16 starts from the region near fixed point (P) as shown by FIG. 4A, and progresses continuously to the region farthest from fixed point (P), thereby completely separating current breaking portion 16a from tab plate 16 as shown by FIG. 4B.

The progression of separation of current breaking portion 16a is a attributable to the shape of current breaking portion 16a, because fixed point (P) is not coincident with the center of current breaking point 16a. Notch 16c or slit 16earranged along the periphery of circumference of current breaking portion 16a may facilitate the separation of current breaking portion 16a from tab plate 16.

When the secondary battery is under an abnormal condition caused by an increase of internal pressure, the separation of current breaking portion 16a enables the secondary battery to maintain a safe condition by breaking of the electrical current path that connects the positive electrode of electrode assembly 8 to cap assembly 14.

Furthermore, when internal pressure inside a secondary battery continues to increase even after the above stage, and a possibility of explosion or ignition of the battery continues to exist; in design of this first embodiment, vent 18a then raptures along notch 15b and partially separates from vent plate 18 so that the gas is allowed to immediately discharge en mass, outward from the interior of container 10 via cap assembly 14, thereby further enhancing the safety condition (See FIG. 3C).

A secondary battery constructed according to the principles of the present invention enforces the fixation strength of the region where tab plate 16 and vent plate 18 are fixed and thereby reduces the contact resistance of the region. This facilitates collection of the electrical current from positive electrode 2 of electrode assembly 8 and thereby secure high power performance of the battery.

Moreover, this design for secondary batteries according to the principle of the present invention improves the fixing position between current breaking portion 16a and vent 18a to thereby facilitate the separation between current breaking portion 16a from tab plate 16. Accordingly, current breaking portion 16a can function efficiently as a circuit breaker to interrupt the flow of electrical current between positive electrode tab 20 and vent plate 18.

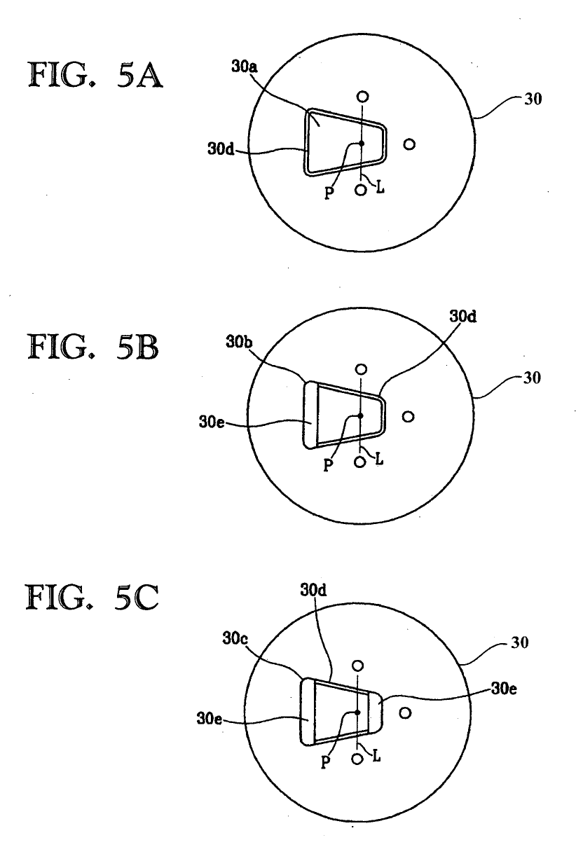

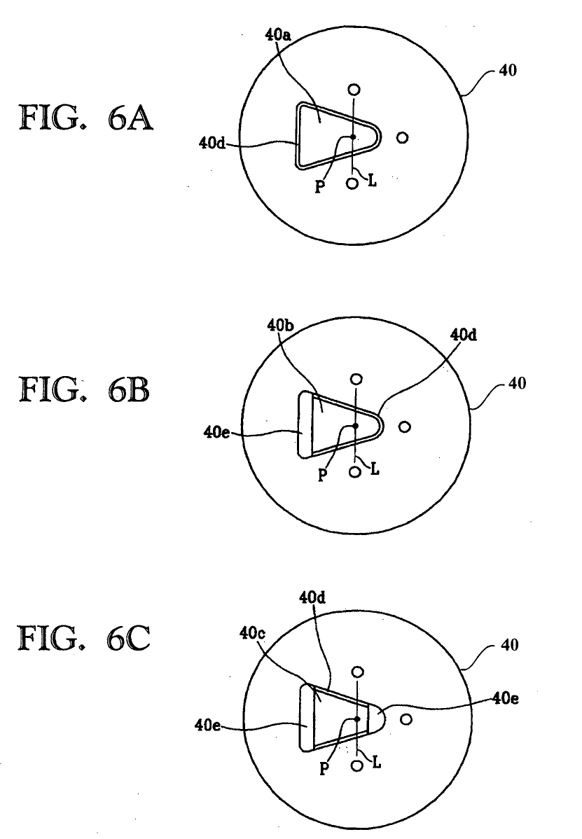

FIGS. 5A to 5C and FIGS. 6A to 6C are bottom views of the underside of tab plates 30, 40 illustrating the current breaking portions for other embodiments of the present invention;

While current breaking portions 30a, 30b and 30c shown in FIGS. 5A to 5C meet the conditions for the current breaking portion mentioned in the above embodiments, their overall shapes are geometric constructs for a trapezoid.

Current breaking portions 30, 30b, and 30c each have a notch 30d along their circumferences of peripheries, and can further include a slit 30e formed along at least a portion of the circumference as well as along a plurality of portions of their peripheries.

FIG. 5A shows a design with no slit, FIG. 5B shows a design with slit 30e formed along one side of current breaking portion 30b, and FIG. 5C shows a design with slits 30e arranged opposite to each other, on opposite sides of fixed point (P).

While current breaking portions 40a,40b and 40c shown in FIGS. 6A, 6B, and 6C also meet the conditions discussed earlier in this detailed description for the current breaking portion mentioned in the designs of the foregoing embodiments, their overall shape is a geometric construct for triangle. Notch 40d and slit 40e formed along the periphery of circumference of each current breaking portion 40a, 40b, and 40c can have the same geometric shape and structure as illustrated by FIGS. 5A, 5B and 5C.

The shape of the current breaking portion for the different embodiment of the present invention is not limited to the above-mentioned shapes, and it may be varied to any other shape as long as the shape meets the conditions and criteria mentioned in the foregoing paragraphs of this detailed description.

The secondary battery in the practice of the present invention minimizes contact resistance factors which can be generated in the path of electrical current flowing from the positive electrode of the electrode assembly, through the positive electrode tab, the tab plate, and the vent plate, to the cap cover, and thereby facilitates a low of electrical current sufficient to provide high electrical power while enhancing the power performance of the battery.

Secondary batteries constructed in the practice of the present invention can be used as the power source for motor driving devices such as hybrid electric vehicles, electric vehicles, wireless vacuum cleaners, motorbikes, and motor scooters.

Although a few embodiments of the present invention have been shown and described, it would be appreciated by those skilled in the art that changes may be made in this embodiment without departing from the principles and spirit of the invention, the scope of which is defined in the claims and their equivalents.

1. A cap assembly for a secondary battery, comprising:
a cap cover;
a tab plate arranged along one side of the cap cover; and
a vent plate arranged between the cap cover and the tab plate;
the tab plate comprising a current breaking portion dedicated to be torn by a predetermined force, and the vent plate comprising a vent dedicated to be altered or broken by a predetermined force; and
the current breaking portion being fixedly attached to the vent at a fixed point, and a center point of the current breaking portion and the fixed point being not coincident.

2. The cap assembly for a secondary battery of claim 1, with the tab plate having a notch formed along a periphery of the current breaking portion.

3. The cap assembly for a secondary battery of claim 1, the tab plate being perforated by at least one ventilation hole.

4. The cap assembly for a secondary battery of claim 1, with the current breaking portion comprising a geometric construct having asymmetric regions bisected on opposite side of a hypothetical line passing through the fixed point are not symmetrical.

5. The cap assembly for a secondary battery of claim 4, with the current breaking portion having a shape of one of a trapezoid or triangle.

6. The cap assembly for a secondary battery of claim 1, with the current breaking portion and the vent being fixedly attached together by welding.

7. The cap assembly for a secondary battery of claim 1, comprising a slit formed between a tab plate and the current breaking portion corresponding to at least a portion of periphery of the current breaking portion.

8. The cap assembly for a secondary battery of claim 7, wherein the slits are arranged on opposite sides of the fixed point.

9. The cap assembly for a secondary battery of claim 1, wherein the cap assembly meets an inequality:
a<b
where “a” is a distance from the fixed point to one point of an edge of the current breaking portion and “b” is a distance from the fixed point to the cap cover.

10. A secondary battery, comprising:
a container;
an electrode assembly mounted in the container having a positive electrode, a negative electrode, and a separator interposed between the positive electrode and the negative electrode; and
a cap assembly fixed to an opening of the container to seal the container;
the cap assembly comprising:
a cap cover;
a tab plate arranged along one side of the cap cover; and
a vent plate arranged between the cap cover and the tab plate;
the tab plate comprising a current breaking portion to be torn by a predetermined force, and the vent plate comprises a vent to be altered by a predetermined force; and
the current breaking portion being fixedly attached to the vent at a fixed point, and a center point of the current breaking portion and the fixed point being not coincident.

11. The secondary battery of claim 10, with the tab plate having a notch formed along a periphery of the current breaking portion.

12. The secondary battery of claim 10, with the current breaking portion comprising a geometric construct having asymmetric regions on opposite sides of a hypothetical line passing through the fixed point.

13. The secondary battery of claim 12, with the current breaking portion having a shape of one of a trapezoid or triangle.

14. The secondary battery of claim 10, with the current breaking portion and the vent being fixedly attached together by welding.

15. The secondary battery of claim 10, comprising a slit is formed between the tab plate and the current breaking portion corresponding to at least a portion of the a periphery of the current breaking portion.

16. The secondary battery of claim 15, wherein the slits are arranged on opposite sides of the fixed point.

17. The secondary battery of claim 16 wherein the cap assembly meets the an inequality:
a<b
where “a” is a distance from the fixed point to one point of an edge of the current breaking portion and “b” is a distance from the fixed point to the cap cover.

18. The secondary battery of claim 10, with the secondary battery having a cylindrical shape.

19. The secondary battery of claim 10, with the secondary battery is for a motor driven device.
